(19) United States
(12) Patent Application Publication
(10) Pub. No.: US 2016/0219988 A1
(43) Pub. Date: Aug. 4, 2016

(54) Buckle Structure for Safety Belt

(71) Applicant: TAIWAN BIKE RACK CO., LTD., Changhuwa Hsien (TW)

(72) Inventor: Chin-Sung Huang, Changhuwa Hsien (TW)

(21) Appl. No.: 14/611,583

(22) Filed: Feb. 2, 2015

(51) Int. Cl. A44B 11/25; B60R 22/00

(52) U.S. Cl. CPC A44B 11/2542; A44B 11/2561; B60R 22/00

(57) ABSTRACT

A buckle structure for a safety belt contains: a base, a cover, a locking device, and a rotating member. The base includes plural retaining grooves, each having a slot. The cover includes an accommodating chamber, and the locking device includes a fixing blot, plural movable bolts, a first spring, a driving piece, a rotary shaft, and a positioning disc. The driving piece has a central hole, a hollow post, and plural gaps. The rotary shaft has two opposite tabs, and the positioning disc has plural orifices. The rotating member is disposed on the cover and connects with the locking device. The elastic member has a sliding block and a resilient element, the sliding block has a notch for inserting a first end of the resilient element, and a second end of the resilient element abuts against an inner end of the slot, wherein the rotary shaft has a peripheral rib.

### BACKGROUND OF THE INVENTION

1. Field of the Invention

The present invention relates to a buckle for a safety belt, and more particularly to a buckle structure for a racing automobile.

2. Description of the Prior Art

A conventional safety belt is fixed in a vehicle to protect a driver and passenger(s). For example, in a car crash, the conventional safety belt ties the driver and the passenger(s) securely on seats to avoid the driver and the passenger(s) hitting steering wheel and windshield.

A buckle is connected with a safety belt and is used for common automobile or racing car. For example, a buckle structure for the racing car contains a buckle piece inserted into a retaining groove quickly, such that the buckle piece is fixed by one of movable bolts, and an end portion of the buckle piece abuts against the elastic member. When desiring to unbuckle the safety belt, a rotating portion drives the one of the movable blots to remove from the buckle piece, and then the elastic member pushes the buckle piece outwardly, thus unbuckling the safety belt.

However, the elastic member of the buckle structure has a fitting stem, a spring fitted on the fitting stem, and a sliding block with a shoulder, wherein the fitting stem is fitted into the sliding block, and the elastic member is mounted in a trench of a holder so that the sliding block slides in the trench. Accordingly, the elastic member has many related components, is assembled difficulty and is produced at a high cost. Furthermore, an end portion of the spring gets stuck between the fitting stem and the sliding block to operate the buckle structure roughly.

The present invention has arisen to mitigate and/or obviate the afore-described disadvantages.

### SUMMARY OF THE INVENTION

The primary objective of the present invention is to provide a buckle structure for a safety belt in which an elastic member has a sliding block and a resilient element to reduce related components of the elastic member, to assemble the buckle structure easily, and to lower production cost of the buckle structure.

To obtain above-mentioned objectives, a buckle structure for a safety belt provided by the present invention contains: a base, a cover, a locking device, and a rotating member.

The base includes a plurality of retaining grooves defined around a peripheral side of a top surface thereof, each retaining groove having a slot formed on a central portion thereof to accommodate an elastic member.

The cover is covered on the base and includes an accommodating chamber formed therein.

The locking device is mounted in the accommodating chamber of the cover and includes a fixing blot, plural movable bolts, a first spring, a driving piece, a rotary shaft, and a positioning disc, wherein the fixing bolt and the plural movable bolts cooperate with a plurality of second springs and are fitted on plural columns of the cover, the first spring and the driving piece are accommodated in the accommodating chamber of the cover, such that the first spring abuts against the cover and the driving piece, and the driving piece has a central hole defined on a central position thereof, a hollow post with two oppositely V-shaped cutouts, and plural gaps formed around a peripheral side thereof to retain with the fixing blot and the plural movable bolts, the rotary shaft extends out of the cover via the central hole of the driving piece and the first spring, the rotary shaft has two opposite tabs arranged on a peripheral side thereof, wherein the two opposite tabs are located at two bottom ends of the two oppositely V-shaped cutouts of the hollow post, and the rotary shaft and the driving piece are pushed by the first spring to move back to an original position, the positioning disc is mounted between the cover and the base and has a plurality of orifices formed adjacent to a peripheral side thereof to insert the fixing blot and the plural movable bolts.

The rotating member is disposed on the cover and connects with the locking device, such that the rotating member drives the locking device to rotate.

The elastic member has a sliding block and a resilient element, the sliding block has a notch for inserting a first end of the resilient element, and a second end of the resilient element abuts against an inner end of the slot, wherein the rotary shaft has a peripheral rib extending outwardly around a bottom end of an outer wall thereof and fixed above the resilient element which is inserted into the notch of the sliding block, such that the resilient element is limited by the notch of the sliding block and the peripheral rib of the rotary shaft.

### BRIEF DESCRIPTION OF THE DRAWINGS

FIG. 1 is a perspective view showing the assembly of a buckle structure for a safety belt according to a preferred embodiment of the present invention.

FIG. 2 is a perspective view showing the exploded components of the buckle structure for the safety belt according to the preferred embodiment of the present invention.

FIG. 3 is a perspective view showing the assembly of a cover of the buckle structure for the safety belt according to the preferred embodiment of the present invention.

FIG. 4 is a perspective view showing the assembly of a driving piece of the buckle structure for the safety belt according to the preferred embodiment of the present invention.

FIG. 5 is a cross sectional view showing the assembly of the buckle structure for the safety belt according to the preferred embodiment of the present invention.

FIG. 6 is a cross sectional view showing the operation of the buckle structure for the safety belt according to the preferred embodiment of the present invention.

FIG. 7 is another cross sectional view showing the operation of the buckle structure for the safety belt according to the preferred embodiment of the present invention.

FIG. 8 is also cross sectional view showing the operation of the buckle structure for the safety belt according to the preferred embodiment of the present invention.

### DETAILED DESCRIPTION OF THE PREFERRED EMBODIMENTS

The present invention will be clearer from the following description when viewed together with the accompanying drawings, which show, for purpose of illustrations. only, a preferred embodiment in accordance with the present invention.

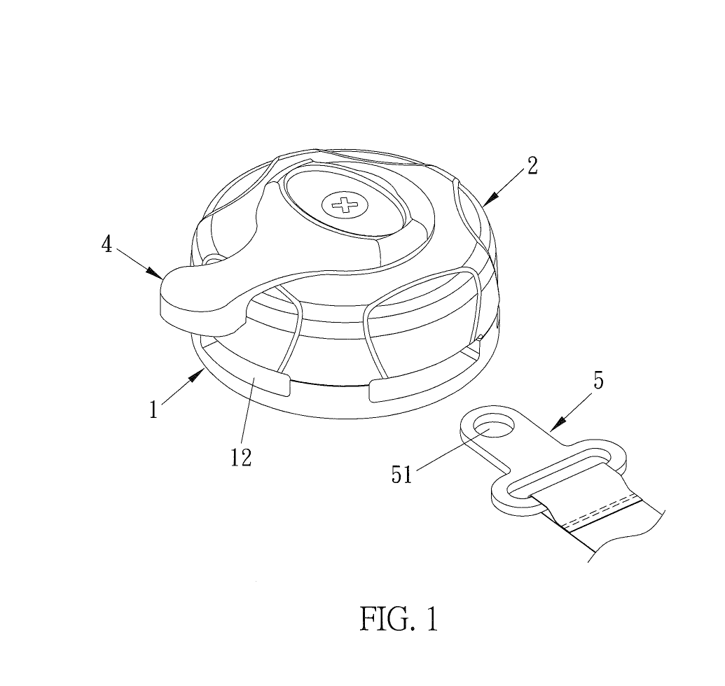

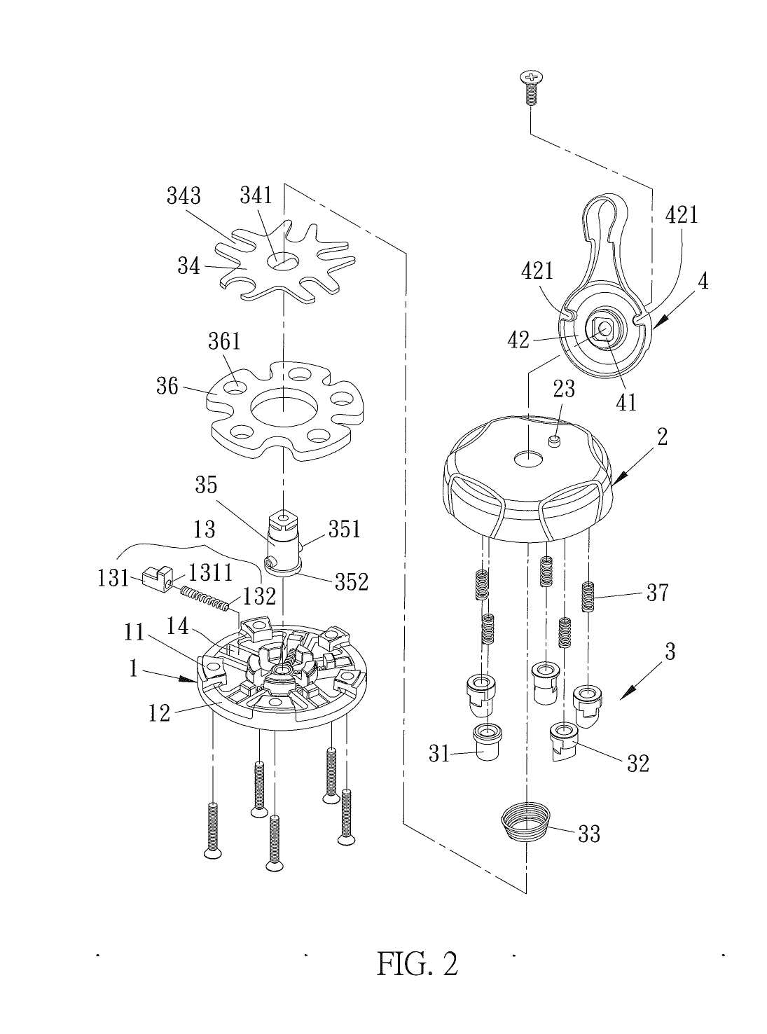

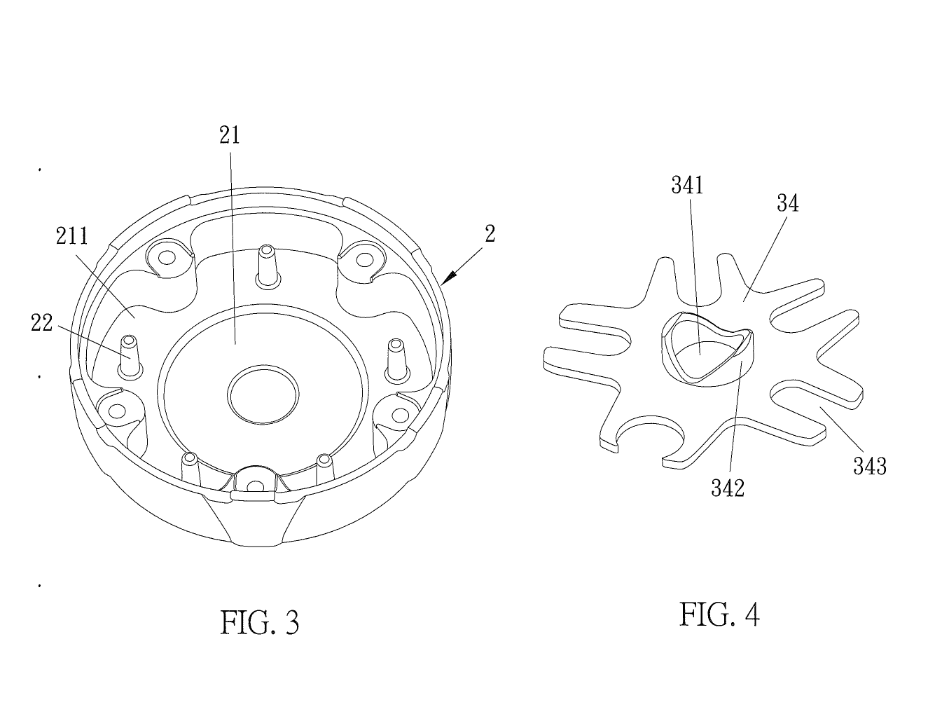

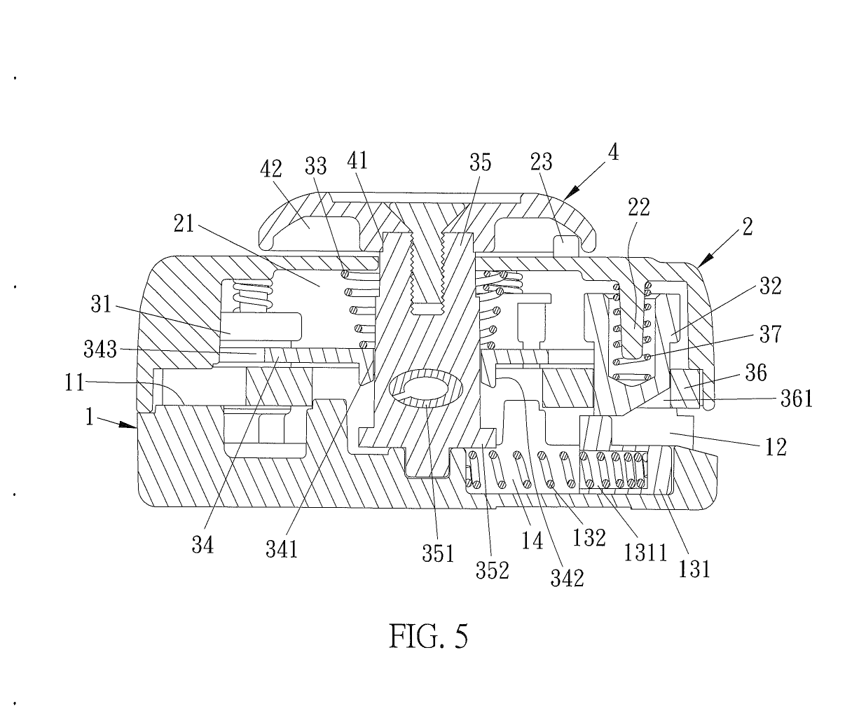

With reference to FIGS. 1 to 5, a buckle structure for a safety belt according to a preferred embodiment of the present invention comprises: a base 1, a cover 2, a locking device 3, and a rotating member 4. The base 1 includes a plurality of protrusions 11 separately arranged around a peripheral side of a top surface thereof, wherein between any two protrusions 11 is defined a retaining groove 12, the retaining groove 12 has a slot 14 formed on a central portion thereof to accommodate an elastic member 13, and the elastic member 13 has a sliding block 131 and a resilient element 132, wherein the sliding block 131 has a notch 1311 defined on an inner end thereof to insert a first end of the resilient element 132, and a second end of the resilient element 132 abuts against an inner end of the slot 14, wherein the resilient element 132 is a compression spring. The cover 2 is covered on the base 1 and is screwed by at least one screwing element, and the cover 2 includes an accommodating chamber 21 formed therein, the accommodating chamber 21 has a plurality of recessed portions 211 arranged on an outer rim thereof, and each recessed portion 211 has a column 22 extending downwardly therefrom. The cover 2 also includes a limiting projection 23 arranged on a top surface thereof. The locking device 3 is mounted in the accommodating chamber 21 of the cover 2 and includes a fixing blot 31, plural movable bolts 32, a first spring 33, a driving piece 34, a rotary shaft 35, and a positioning disc 36, wherein the fixing bolt 31 and the plural movable bolts 32 cooperate with a plurality of second springs 37 and are fitted on plural columns 22 of the cover 2, the first spring 33 and the driving piece 34 are accommodated in the accommodating chamber 21 of the cover 2 so that the first spring 33 abuts against the cover 2 and the driving piece 34, and the driving piece 34 has a central hole 341 defined on a central position thereof, a hollow post 342 with two oppositely V-shaped cutouts, and plural gaps 343 formed around a peripheral side thereof to retain with the fixing blot 31 and the plural movable bolts 32. The rotary shaft 35 extends out of the cover 2 via the central hole 341 of the driving piece 34 and the first spring 33, such that the driving piece 34 and the first spring 33 are fitted on the rotary shaft 35. The rotary shaft 35 has two opposite tabs 351 arranged on a peripheral side thereof, wherein the two opposite tabs 351 are located at two bottom ends of the two oppositely V-shaped cutouts of the hollow post 342, and the rotary shaft 35 and the driving piece 34 are pushed by the first spring 33 to move back to an original position. The rotary shaft 35 has a peripheral rib 352 extending outwardly around a bottom end of an outer wall thereof and fixed above the resilient element 132 which is inserted into the notch 1311 of the sliding block 131, such that the resilient element 132 is limited by the notch 1311 of the sliding block 131 and the peripheral rib 352 of the rotary shaft 35, the resilient element 132 presses, expands, and abuts against the inner end of the slot 14 and the inner end of the notch 1311 of the sliding block 131 to avoid elasticity fatigue. The positioning disc 36 is mounted between the cover 2 and the base 1 and has a plurality of orifices 361 formed adjacent to a peripheral side thereof to insert the fixing blot 31 and the plural movable bolts 32. The rotating member 4 is disposed on the cover 2 and includes a recess 41 defined on a central position of a bottom end thereof to fit with an upper end of the rotary shaft 35, and the rotating member 4 is screwed with the rotary shaft 35 by ways of a screw, such that the rotating member 4 drives the rotary shaft 35 of the locking device 3 to rotate. The rotating member 4 includes a circular trench 42 formed on the bottom end thereof, and the circular trench 42 has two affix portions 421 fixed therein to match with the limiting projection 23 of the cover 2, thus limiting a rotating angle of the rotating member 4.

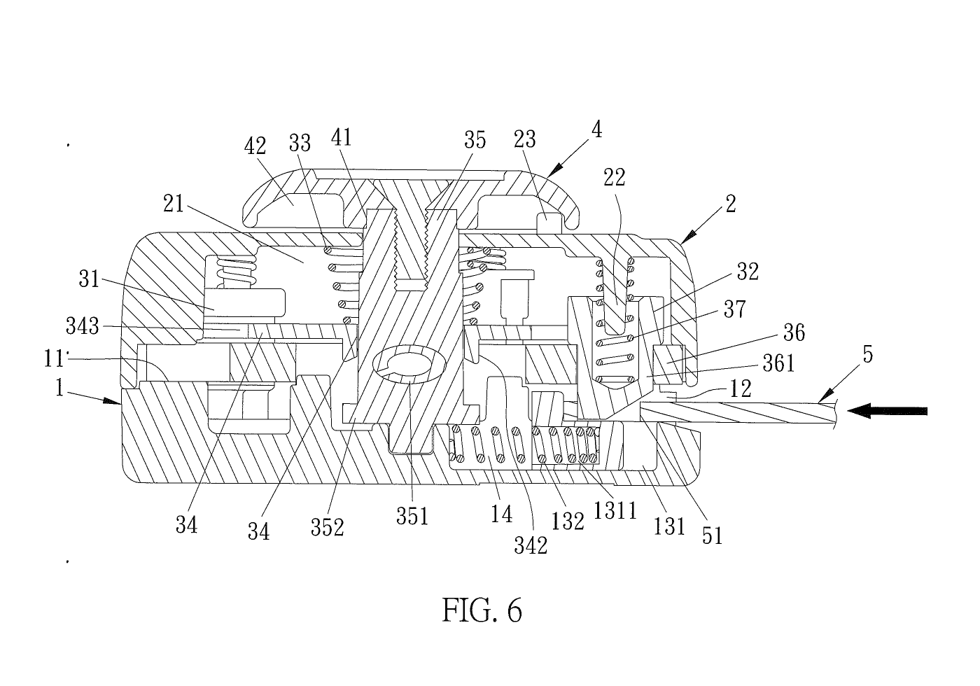

In operation, as illustrated in FIG. 6, a buckle piece 5 is inserted into the retaining groove 12 of the base 1 and its front end pushes the sliding block 131 of the elastic member 13 into the slot 14, such that the sliding block 131 slides into the slot 14, and the resilient element 132 is pressed by the sliding block 131. After the buckle piece 5 is positioned, one of the plural movable bolts 32 of the locking device 3, which corresponds to the buckle piece 5, inserts into an aperture 51 of the buckle piece 5 by using one of the plurality of second springs 37, thus buckling the buckle piece 5.

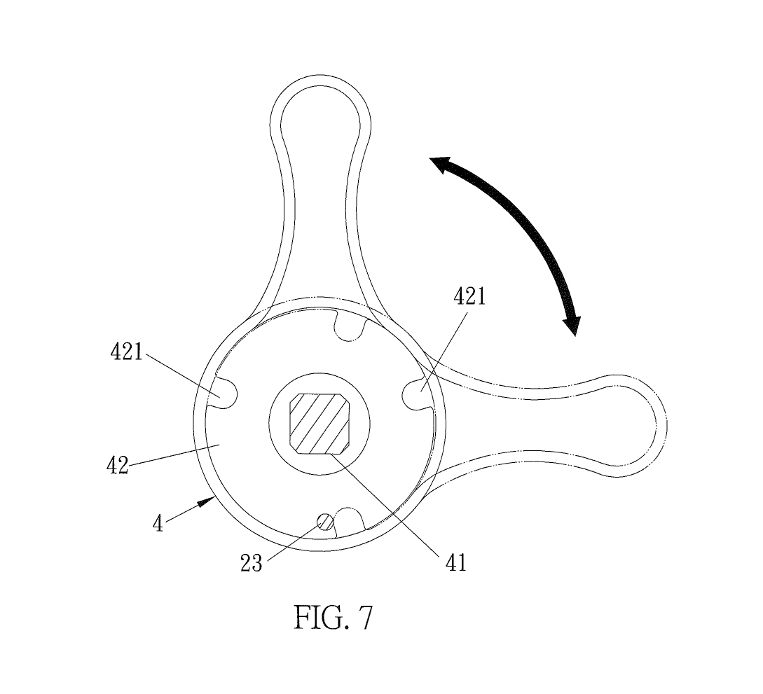

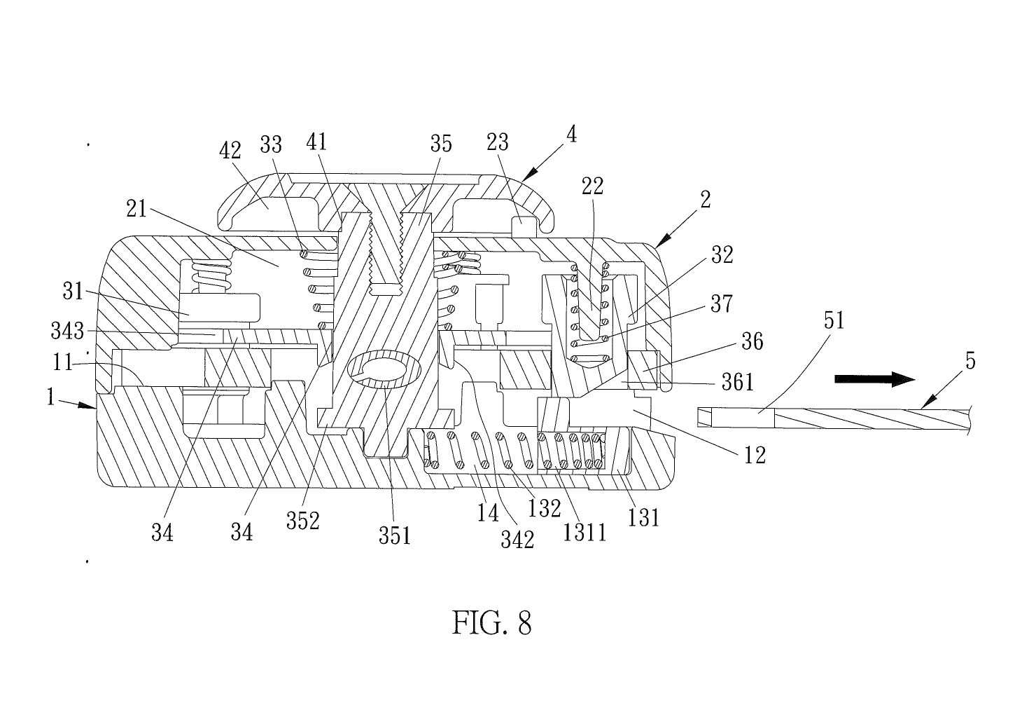

As desiring to unbuckle the safety belt, as shown in FIGS. 7 and 8, the rotating member 4 drives the rotary shaft 35 to rotate, and the rotating angle of the rotating member 4 is limited since the two affix portions 421 engage with the limiting projection 23 of the cover 2, hence the two opposite tabs 351 of the rotary shaft 35 slide toward two edges of the hollow post 342 from the two bottom ends of the two oppositely V-shaped cutouts of the hollow post 342, and the driving piece 34 is pushed upwardly by the two opposite tabs 351 to press the first spring 33, to push the plural movable bolts 32 upwardly, and to press the plurality of second springs 37. Thereafter, the one of the plural movable bolts 32 disengages from the aperture 51 of the buckle piece 5, the resilient element 132 of the elastic member 13 pushes the sliding block 131 to move outwardly, such that the sliding block 131 pushes the buckle piece 15 out of the retaining groove 12, thus unbuckling the buckle piece easily. After unbuckling the buckle piece, the first spring 33 and the plurality of second springs 37 push the driving piece 34 and the plural movable bolts 32 back to the original position, hence the rotary shaft 35 and the rotating member 4 reversely rotate back to an original angle.

Accordingly, the buckle structure of the present invention has advantages as follows:

The elastic member 13 of the buckle structure has the sliding block 131 and the resilient element 132, the first end of the resilient element 132 inserts into the notch 1311 of the sliding block 131, and the second end of the resilient element 132 is limited by the peripheral rib 352 of the rotary shaft 35, such that the resilient element 132 abuts against the inner end of the slot 14 and the inner end of the notch 1311 of the sliding block 131 to avoid elasticity fatigue, to reduce related components of the elastic member 13, to assemble the buckle easily, and to lower production cost of the buckle structure.

While various embodiments in accordance with the present invention have been shown and described, it is clear to those skilled in the art that further embodiments may be made without departing from the scope of the present invention.

What is claimed is:

1. A buckle structure for a safety belt comprising:
a base including a plurality of retaining grooves defined around a peripheral side of a top surface thereof, each retaining groove having a slot formed on a central portion thereof to accommodate an elastic member;
a cover covered on the base and including an accommodating chamber formed therein;
a locking device mounted in the accommodating chamber of the cover and including a fixing blot, plural movable bolts, a first spring, a driving piece, a rotary shaft, and a positioning disc, wherein the fixing bolt and the plural movable bolts cooperate with a plurality of second springs and are fitted on plural columns of the cover, the first spring and the driving piece are accommodated in the accommodating chamber of the cover, such that the first spring abuts against the cover and the driving piece, and the driving piece has a central hole defined on a central position thereof, a hollow post with two oppositely V-shaped cutouts, and plural gaps formed around a peripheral side thereof to retain with the fixing blot and the plural movable bolts, the rotary shaft extends out of the cover via the central hole of the driving piece and the first spring, the rotary shaft has two opposite tabs arranged on a peripheral side thereof, wherein the two opposite tabs are located at two bottom ends of the two oppositely V-shaped cutouts of the hollow post, and the rotary shaft and the driving piece are pushed by the first spring to move back to an original position, the positioning disc is mounted between the cover and the base and has a plurality of orifices formed adjacent to a peripheral side thereof to insert the fixing blot and the plural movable bolts;
a rotating member disposed on the cover and connecting with the locking device, such that the rotating member drives the locking device to rotate; characterized in that:
the elastic member has a sliding block and a resilient element, the sliding block has a notch for inserting a first end of the resilient element, and a second end of the resilient element abuts against an inner end of the slot, wherein the rotary shaft has a peripheral rib extending outwardly around a bottom end of an outer wall thereof and fixed above the resilient element which is inserted into the notch of the sliding block, such that the resilient element is limited by the notch of the sliding block and the peripheral rib of the rotary shaft.

2. The buckle structure for the safety belt as claimed in claim 1, wherein the resilient element is a compression spring.

3. A buckle structure for a safety belt comprising:
a base including a plurality of retaining grooves defined around a peripheral side of a top surface thereof, each retaining groove having a slot formed on a central portion thereof to accommodate an elastic member;
a cover covered on the base and including an accommodating chamber formed therein;
a locking device mounted in the accommodating chamber of the cover and including a fixing blot, plural movable bolts, a first spring, a driving piece, a rotary shaft, and a positioning disc, wherein the fixing bolt and the plural movable bolts cooperate with a plurality of second springs and are fitted on plural columns of the cover, the first spring and the driving piece are accommodated in the accommodating chamber of the cover, such that the first spring abuts against the cover and the driving piece, and the driving piece has a central hole defined on a central position thereof, a hollow post with two oppositely V-shaped cutouts, and plural gaps formed around a peripheral side thereof to retain with the fixing blot and the plural movable bolts, the rotary shaft extends out of the cover via the central hole of the driving piece and the first spring, the rotary shaft has two opposite tabs arranged on a peripheral side thereof, wherein the two opposite tabs are located at two bottom ends of the two oppositely V-shaped cutouts of the hollow post, and the rotary shaft and the driving piece are pushed by the first spring to move back to an original position, the positioning disc is mounted between the cover and the base and has a plurality of orifices formed adjacent to a peripheral side thereof to insert the fixing blot and the plural movable bolts;
a rotating member disposed on the cover and connecting with the locking device, such that the rotating member drives the locking device to rotate; characterized in that:
the elastic member has a sliding block and a resilient element, the sliding block has a notch for inserting a first end of the resilient element, and a second end of the resilient element abuts against an inner end of the slot, wherein the rotary shaft has a peripheral rib extending outwardly around a bottom end of an outer wall thereof and fixed above the resilient element which is inserted into the notch of the sliding block, such that the resilient element is limited by the notch of the sliding block and the peripheral rib of the rotary shaft, the cover also includes a limiting projection arranged on a top surface thereof, the rotating member includes a circular trench formed on the bottom end thereof, and the circular trench has two affix portions fixed therein to match with the limiting projection of the cover, thus limiting a rotating angle of the rotating member.

4. The buckle structure for the safety belt as claimed in claim 3, wherein the resilient element is a compression spring.
